(19) United States
(12) Patent Application Publication
(10) Pub. No.: US 2016/0083996 A1
(43) Pub. Date: Mar. 24, 2016

(54) Window pan drainage dam

(71) Applicant: EZEE DAM INC., Calgary (CA)

(72) Inventor: Michael R. Albert, Calgary (CA)

(73) Assignee: EZEE DAM INC.

(21) Appl. No.: 14/121,604

(22) Filed: Sep. 24, 2014

(51) Int. Cl. E06B 7/14; E06B 7/23; E06B 1/70

(52) U.S. Cl. CPC E06B 7/14; E06B 1/702; E06B 7/2314

(57) ABSTRACT

A system and components for a window pan water dam system is disclosed. The object of invention is to deflect water from the window base sill plate back towards the exterior drainage plain of the building envelope, thus ensuring water ingress does not occur through the sill pan area and the side walls of the windows opening.

### FIELD OF INVENTION

The invention relates to a system/assembly (and components) for a window pan drainage dam system it manages moisture and water build-up by redirecting the water or moisture away from the interior of a building redirecting it to the exterior building envelope drainage plain thus re directing moisture away from the window pan area. The object of the invention is to provide a consistent durable product that does not rot, it is user friendly to install uniformly designed for ease of inspection, promoting drainage to the exterior building envelope.

### BACKGROUND

Window openings of buildings are of reinforced concrete, steel, wood and concrete like materials have window openings in various locations of the buildings structural exterior walls. The window openings in a building must integrate with the exterior building envelope to protect the penetrations and exterior of the building structure as a whole. Building envelope is meant to protect the building's structure from water ingress, wind and thermal transfer that causes structural damage, mold, rot and general decay of a building and its structure.

Certain types of walls of buildings have an inner cavity between the outside cladding and the inner wall consisting of plasterboard material. The said cavity permits air movement with the outside atmosphere to provide an air equalization chamber, a thermal break and moisture vent conduit for moisture infiltration through the exterior cladding. Over time by action of wind, rain, temperature freeze and thaw small cracks on the exterior of buildings and or the windows themselves allows further water infiltration and condensation (wicking affect) of that first defence is realised and defeated. The window pan drainage dam system is tied into the components (peal and stick membrane/primer) of a buildings envelope ensures water ingress and condensation that occurs by thermal conditions in the window pan area are directed away from causing building failure of the window pan area.

### SUMMARY

It is conceived to deflect water from the window base sill plate back towards the exterior drainage plain of the building envelope, thus ensuring water ingress does not occur through the sill pan area and the side walls of the windows opening.

A window pan drainage dam assembly for a windows sill plate may be made from light weight PVC. The assembly may comprise of a PVC extruded sill strip that slopes from back to front when installed on a sill plate, such as with nails or screws to butt up to left and right universal 90 degree sloped corner dams that may be injection molded and may also be comprised of PVC, creating a finished dam system for the sill plate and the vertical wall of the window opening that may extend upwards at least 4 inches. Universal injection molded corner dams and the center extruded dam strip may have hollow areas to restrict buckling and warping.

The window pan drainage dam assembly may comprise of a wide range of single component plastics and mixtures of plastic materials including but not limited to: PVC based, Polystyrenes based, Rubber based, Silicone based, Wood based and Fibreglass based of various widths with a back to front sloped profile.

The window pan drainage dam assembly may also include but is not limited to a single component of galvanized steel, metal products, man made compositions, Composite materials natural or manmade, of various sizes with a back to front sloped profile.

The window pan drainage dam assembly of claim can maintain a back to front profile and height dimensions however the width dimensions and slope can vary to accommodate different wall assemblies and rough openings that are of various sizes and widths.

The window pan drainage dam assembly may be manufactured by means of Manual fabrication, Extrusion, Mold injection, casting, 3D printing, CNC fabrication or Templating.

The window pan drainage dam assembly elements may communicate with each other to form a continuous window pan drainage dam profile from end to end of the sill plate with the universal corner dams ensuring the system extends up the vertical studs of the rough opening at least 4 inches providing protection from wicking moisture and condensation.

The window pan drainage dam assembly may be mechanically fastened to the sill plate and the left and right wall stud of the rough opening.

The window pan drainage dam assembly which is ready for primer, oil or latex based and for its peal and stick membrane or self adhesive peal and stick membrane, this seals the pan area and the dam system.

The window pan drainage dam assembly can form a complete uninterrupted seal thus allowing the assembly to properly manage the moisture and water ingress occurring in a window pan area readying the window to be installed.

The window pan drainage dam assembly of claim may channel and permit moisture to drain and air to circulate to effectively allow a window pan area to dry itself

### DESCRIPTION OF DRAWINGS

FIG. 1 Shows the end profile view of the sill strip that has a slope to shed and promote water drainage.

FIG. 2 Shows the universal corner that is sloped on both the base and its vertical side directing and forcing water and condensate back down into the pan area not allowing it to reverse into the building's interior.

FIG. 3 Shows the back view of the universal corner.

### DETAILED DESCRIPTION

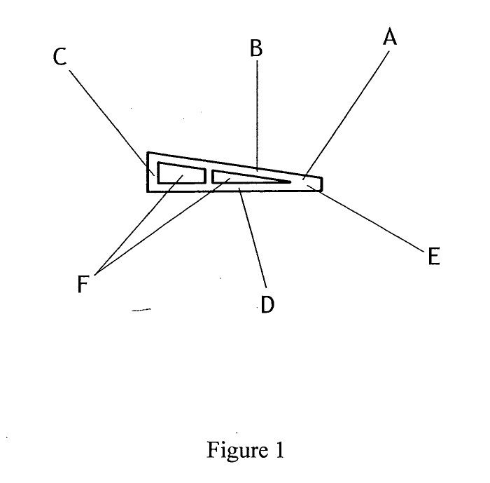

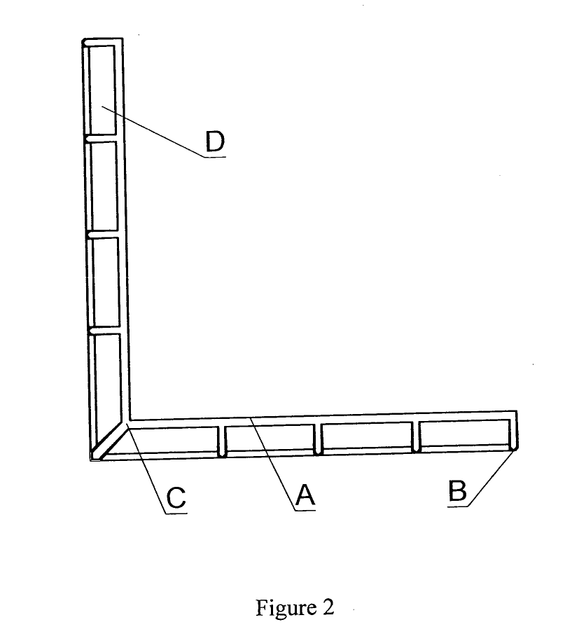

FIG. 1 illustrates a side profile of the center extruded dam strip A. Formed by extrusion of PVC vinyl or various combinations of plastic materials B. Identifies the slope of the dam from back to front this slope can vary in degree of slope depending on the width of a pan area C. This is the rear of the center strip the height of this is ⅜″ no matter the width of the center dam strip D. This is the base portion of the dam and maintains a flat horizontal profile E. This is the front of the center strip this height is constant no matter the width of the center dam strip. FIG. 2 illustrates a side view of the universal corner dam A Formed by the method of injection molding with a PVC vinyl or various combinations of plastic materials B. This shows the base of the corner and identifies it's slope from back to front slope can vary in degree of slope depending on the width of a pan area C This shows the vertical portion of the universal corner that is slope with the same degree as the base of the corner or other various sizes of the center dam strip D This is the front of the universal corner this height is constant no matter the width of the center dam strip E This is the rear of the center strip the height of this is ⅜″ no matter the width of the center dam strip.

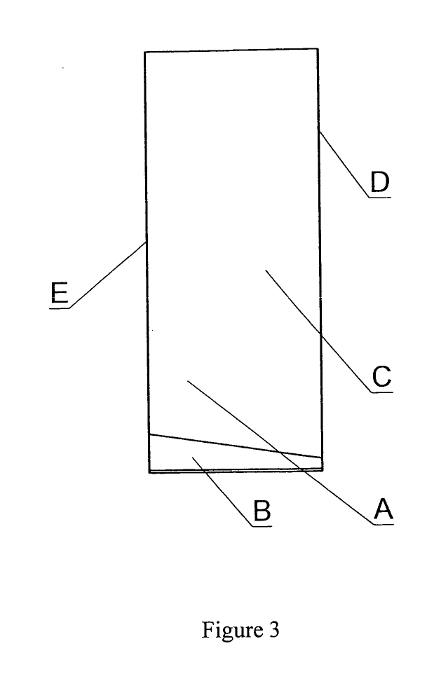

FIG. 3 Illustrates a rear view of the Universal corner dam A Formed by the method of injection molding with a PVC vinyl or various combinations of plastic materials B this is a support leg of which there are 8 in total 4 for the horizontal portion of the corner and 4 for the universal vertical portion of the universal corner dam C This is a support leg for the universal corner dam D this represents hollow portions of the corner This eliminates the base portion that is require for the center dam strip.

1. A window pan drainage dam assembly for a windows sill plate that may be made from light weight PVC, said assembly comprising of, a preferably PVC, extruded sill strip that slopes from back to front that is installed on the sill plate such as with nails or screws to butt up to the left and right universal 90 degree sloped injection molded corner dams, that also are preferably comprised of PVC, creating a finished dam system for the sill plate and the vertical wall of the window opening that may extend upwards at least 4 inches, the Universal injection molded corner dams and the center extruded dam strip may also have hollow areas to restrict buckling and warping.

2. The window pan drainage dam assembly of claim 1 which can comprise of a wide range of single component plastics and mixtures of plastic materials including but not limited to: PVC based, Polystyrenes based, Rubber based, Silicone based, Wood based and Fibreglass based of various widths with a back to front sloped profile.

3. The window pan drainage dam assembly of claim 2 which can also include but is not limited to a single component of Galvanized steel, Metal products man made composition, Composite materials natural or manmade, of various sizes with a back to front sloped profile.

4. The window pan drainage dam assembly of claims 2 and 3 will maintain a back to front profile and height dimensions however the width dimensions and slope can vary to accommodate different wall assemblies and rough openings that are of various sizes and widths.

5. The window pan drainage dam assembly of claim 4 which ca be manufactured by means of Manual fabrication, Extrusion, Mold injection, casting, 3D printing, CNC fabrication or Templating.

6. The window pan drainage dam assembly of claim 5 communicate with each other to form a continuous window pan drainage dam profile from end to end of the sill plate with the universal corner dams ensuring the system extends up the vertical studs of the R.O 4 inches providing protection from wicking moisture and condensation.

7. The window pan drainage dam assembly of claim 6 which can be mechanically fastened to the sill plate and the left and right wall stud of the rough opening.

8. The window pan drainage dam assembly of claim 7 which is ready for primer, oil or latex based and for its peal and stick membrane or self adhesive peal and stick membrane, this seals the pan area and the dam system.

9. The window pan drainage dam assembly of claim 8 which forms a complete uninterrupted seal thus is allowing the assembly to properly manage the moisture and water ingress occurring in a window pan area readying the window to be installed.

10. The window pan drainage dam assembly of claim 9 that channels and permits moisture to drain and air to circulate to effectively allow a window pan area to dry itself.
